(19) United States
(12) Patent Application Publication
(10) Pub. No.: US 2011/0183680 A1
(43) Pub. Date: Jul. 28, 2011

(54) SOUNDING SEQUENCE ALLOCATION METHOD IN WIRELESS COMMUNICATION SYSTEM AND CONTROL SYSTEM THEREOF

(75) Inventors: Byoung-Ha YI, Seoul (KR); Ki-Young HAN, Yongin-si (KR)

(73) Assignee: SAMSUNG ELECTRONICS CO. LTD., Suwon-si (KR)

(21) Appl. No.: 13/006,779

(22) Filed: Jan. 14, 2011

(30) Foreign Application Priority Data
Jan. 22, 2010 (KR) 10-2010-0005873

(51) Int. Cl. H04W 72/04

(52) U.S. Cl. 455/450

(57) ABSTRACT

A sounding sequence allocation method in a base station of a wireless communication system and a control system thereof are provided. The method includes, determining a cyclic shift index set different from a cyclic shift index set used by at least one second indoor base station among the plurality of indoor base stations, determining a shift value different from a shift value used by at least one indoor base station located at a periphery, and allocating a sounding sequence with cyclic shift indexes included in the determined cyclic shift index set and the determined shift value to a first indoor base station. The method may provide sounding sequence allocation minimizing interference with another outdoor or indoor base station and reduce maintenance and management costs of a system.

### PRIORITY

This application claims the benefit under 35 U.S.C. §119(a) of a Korean patent application filed in the Korean Intellectual Property Office on Jan. 22, 2010 and assigned Serial No. 10-2010-0005873, the entire disclosure of which is hereby incorporated by reference.

### BACKGROUND OF THE INVENTION

1. Field of the Invention

The present invention relates to a sounding sequence allocation method in a base station of a wireless communication system and a control system thereof. More particularly, the present invention relates to a sounding sequence allocation method in a base station using beam-forming technology and a control system thereof.

2. Description of the Related Art

Current wireless communication systems are progressing to provide various services to users based on high data transmission rate. High data transmission rates may be achieved by increasing a system capacity through cell size reduction, increasing the use of a small indoor base station in an enterprise/home environment, and using a multiple antenna system.

An increased use of the small indoor base station requires optimization of a continuous network suitable for frequent transitions between base stations. This results in an increase of maintenance and management costs of a system. Accordingly, Self-Organization Network (SON) technology is suggested to reduce increased maintenance and management costs of a system. Standardization of the SON technology is achieved by the 3rd Generation Partnership Project (3GPP) Long Term Evolution (LTE) standard, and the Institute of Electrical and Electronics Engineers (IEEE) 802.16m standard.

In a technology using multiple antennas, a beam is formed toward a desired direction based on an estimation of a wireless environment between a base station and a user to apply beam-forming technology for increasing a performance of the base station.

A sounding sequence is used for the purpose of estimating the wireless environment between a base station and a user in an IEEE 802.16e system. To apply the SON technology to an indoor wireless communication system using the beam-forming technology, the sounding sequence should be automatically set and optimized.

Since the wireless channel environments and the typical user's purpose of communicating on an existing outdoor mobile communication system versus an indoor near distance communication system differ from each other, different systems have been developed for the different locations. The outdoor mobile communication system has been developed to provide voice communication in a mobile environment, such as a Global System for Mobile Communications (GSM) system, an Interim Standard 95 (IS-95) system, a Wideband Code Division Multiple Access (WCDMA) system, or a Code Division Multiple Access 2000 (CDMA-2000) system. Meanwhile, in the indoor near distance communication system, Wireless Local Area Network (WLAN) technology, such as the IEEE 802.11 standard, has been developed to have data communication in an indoor still environment.

To meet a user's various complicated demands, a future communication system should simultaneously provide various types of communication services, such as voice, data, and multi-media and provide an efficient communication service for use at anytime and anywhere.

To meet a user's requirements, it is possible to provide a communication service simultaneously using different systems including an outdoor mobile communication system and an indoor near distance communication system. However, the foregoing method has problems in that an interworking procedure is complicated, a delay time is long, and complexity of a terminal is high.

Accordingly, a method for using both an outdoor mobile communication system and an indoor near distance communication system is suggested by manufacturing a small outdoor mobile communication base station and installing it indoors.

An indoor base station to which beam-forming technology is applied in the foregoing method should be automatically set and optimized to minimize mutual interference between a sounding sequence for wireless environment acquisition with a user and a sounding sequence of an outdoor base station and an indoor base station.

Therefore, a need exists for a method for automatically allocating a sounding sequence during installation and operation of an indoor base station, and a control system thereof.

### SUMMARY OF THE INVENTION

An aspect of the present invention is to address at least the above-mentioned problems and/or disadvantages and to provide at least the advantages described below. Accordingly, an aspect of the present invention is to provide a method for automatically allocating a sounding sequence during installation and operation of an indoor base station, and a control system thereof.

Another aspect of the present invention is to provide a sounding sequence allocation method for minimizing interference with an outdoor base station or a neighbor indoor base station, and a control system thereof.

In accordance with an aspect of the present invention, a method for allocating a sounding sequence to a plurality of indoor base stations in a wireless communication system is provided. The method includes, determining a cyclic shift index set different from a cyclic shift index set used by at least one second indoor base station among the plurality of indoor base stations, determining a shift value different from a shift value used by at least one indoor base station located at a periphery, and allocating a sounding sequence with cyclic shift indexes included in the determined cyclic shift index set and the determined shift value to a first indoor base station.

In accordance with another aspect of the present invention, a control system for allocating a sounding sequence to a plurality of indoor base stations in a wireless communication system is provided. The control system determines a cyclic shift index set different from a cyclic shift index set used by at least one second indoor base station among the plurality of indoor base stations, determines a shift value different from a shift value using at least one indoor base station located at a periphery, and allocates a sounding sequence with cyclic shift indexes included in the determined cyclic shift index set and the determined shift value to a first indoor base station.

Exemplary embodiments of the present invention provide a sounding sequence allocation minimizing interference with another outdoor or indoor base station that increases a wireless environment estimation performance and enables efficient use of resources.

Furthermore, since exemplary embodiments of the present invention can automatically allocate a sounding sequence, Self-Organization Network (SON) technology is applicable in an indoor base station using beam-forming technology to reduce maintenance and management costs of a system.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a procedure of allocating a cyclic shift index and a shift value to a plurality of indoor base stations according to an exemplary embodiment of the present invention;

FIG. 2 illustrates a procedure of allocating a cyclic shift index according to an exemplary embodiment of the present invention; and

FIGS. 3A and 3B illustrate a procedure of allocating a shift value according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A description of known functions and configurations incorporated herein will be omitted when it may make the subject matter of the present invention rather unclear. Furthermore, various specific definitions found in the following description are provided only to help an understanding of the present invention, and it is apparent to those skilled in the art that the exemplary embodiments of the present invention can be implemented without such definitions.

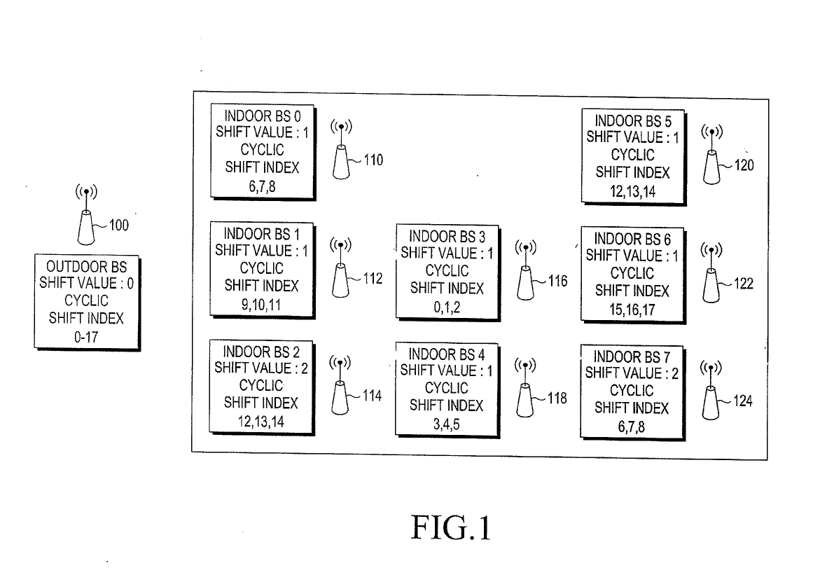

FIGS. 1 through 3B, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

Hereinafter, an automatic sounding sequence allocation method can be performed by a control system controlling a base station. Alternatively, an automatic allocation method can be performed by a controller including one indoor base station. Hereinafter, it should be noted that a control system includes the control system and the controller.

A sounding sequence used for wireless environment estimation, for example, a sounding sequence (bₖ) used for an Institute of Electrical and Electronics Engineers (IEEE) 802.16e system can be defined by Equation (1) below.

$${b}_{k} = \{ \begin{matrix}2 \cdot ( \frac{1}{2} - G ( [ k + u + {offset}_{D} ( fft ) ] mod 2048 ) ) \cdot {e}^{- j \frac{2 π kn}{P}} , & k \neq \frac{{N}_{used} - 1}{2} \\ 0 , & otherwise\end{matrix} \qquad ( 1 )$$

In Equation (1), k represents a subcarrier index, N_{used} represents the number of sub-carriers used for a sounding symbol (namely, a symbol used for the sounding sequence), G(x) represents a golay sequence, P represents a maximum cyclic shift index, n represents a cyclic shift index, u represents a shift value, and offset_{D}(fft) represents an offset according to the Fast Fourier Transform (FFT) size.

As illustrated above, the sounding sequence is generated by applying a cyclic shift index and a shift value to a fundamental sequence (e.g., golay sequence).

Shift values may have a maximum of 128 different values. The shift value is allocated to distinguish base stations from each other, and one shift value is allocated to one base station. Cyclic shift indexes may have different values, and have a value corresponding to a maximum cyclic shift indexes (e.g., P). The cyclic shift index is allocated to identify users and plural (e.g., Nₖ) cyclic shift indexes are allocated to one base station.

Sounding sequence allocation of each base station means to allocate the shift value and a cyclic shift index of Equation (1). That is, the cyclic shift index and the shift value may be used to minimize interferences between users and between base stations of a sounding sequence for wireless channel environment estimation between a base station and a user.

Interference between the outdoor Base Station (BS) and the indoor BS is minimized by using a number of different shift values, and each BS minimizes interference between users using different cyclic shift indexes. More particularly, indoor base stations of one group including P/Nₖ base stations may use the same shift value, and the indoor base stations use Nₖ different cyclic shift indexes to minimize interference of a sounding sequence between base stations and between users.

As used herein, the term “indoor BS” means a micro BS operating a cell with a small coverage, such as a Pico cell or a Femto cell. Moreover, the term “outdoor BS” means a macro BS operating a cell with a large coverage, such as a macro cell.

FIG. 1 illustrates a procedure of allocating a cyclic shift index and a shift value to a plurality of indoor base stations according to an exemplary embodiment of the present invention.

Referring to FIG. 1, an example of allocating a cyclic shift index and a shift value to indoor base stations is provided. It is assumed that a maximum cyclic shift index is 18 (namely, cyclic shift index ranges from 0 to 17) and three cyclic shift indexes are allocated per indoor base station.

A shift value of 0 is allocated to the outdoor base station 100, and a shift value of 1 or 2 is allocated to indoor base stations 110 through 124 located at a periphery of the outdoor base station 100 unlike the outdoor base station. This minimizes interference between the outdoor base station 100 and the indoor base stations 110 through 124.

Since three cyclic shift indexes are allocated to one base station, 18 cyclic indexes can be divided by 6 (18/3=6) different index sets. There are 8 base stations indoors, and different index sets are allocated to six base stations 110, 112, 116, 118, 120, and 120 among the 8 base stations, and a shift value of 1 is equally allocated thereto. The same cyclic shift index set as that of other base stations 120 and 110 is allocated to the remaining two base stations 114 and 124. However, a different shift value 2 from the other base stations 120 and 110 is allocated thereto, thereby minimizing interference of a sounding sequence between base stations and between users.

A sounding sequence allocation procedure according to an exemplary embodiment of the present invention may be divided into two procedures including a cyclic shift index allocation procedure and a shift value allocation procedure.

The following is a description of a cyclic shift index allocation procedure for an indoor base station.

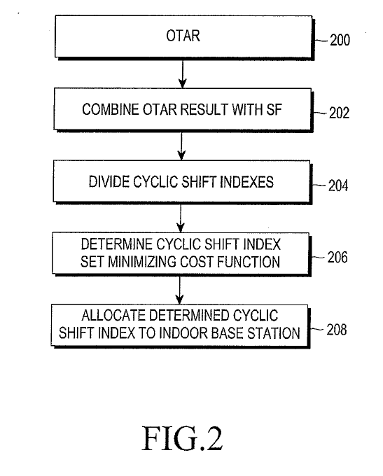

FIG. 2 illustrates a procedure of allocating a cyclic shift index according to an exemplary embodiment of the present invention.

Referring to FIG. 2, each indoor base station performs an Over The Air Receive (OTAR) operation for acquiring a wireless environment with a neighbor base station and estimates a Shadowing Factor (SF) indicating a neighbor shadow fading state in step 200. The OTAR operation means an operation receiving neighbor wireless signals. For example, the OTAR operation includes an operation collecting a level of received power that a corresponding indoor base station receives from another indoor base station.

In step 202, a control system combines an OTAR result from each indoor base station with the estimated SF, and divides P cyclic shift indexes by P/Nₖ sets, each including Nₖ cyclic shift indexes in step 204.

For example, assuming that a maximum cyclic shift index is 18 (namely, cyclic shift index ranges from 0 to 17) and three cyclic shift indexes are allocated to each indoor base station, the cyclic shift indexes can be divided into six sets. Referring to FIG. 1, it can be appreciated that the cyclic shift indexes can be divided into six sets including (0,1,2), (3,4,5), (6,7,8), (9,10,11), (12,13,14), and (15,16,17). Alternatively, cyclic shift indexes included in one set can be divided to have values separated as far as possible from each other.

In step 206, the control system determines a cyclic shift index set minimizing a cost function.

In other words, the control system constructs a cost function minimizing the total amount of indoor interference as defined by Equation (2) below, and determines a cyclic shift index set of each indoor base station minimizing the cost function.

$$Costfunction = {\sum }_{j = 1}^{J} ( ( {\sum }_{{{j}^{′} = 1}_{{{j}^{′} \neq j}_{{{UsedFA}_{{j}^{′}} = {UsedFA}_{j}}_{{Set}_{{j}^{′}} = {Set}_{j}}}}}^{J} {RxP}_{{j}^{′} j} ) / {SF}_{j} ) \qquad ( 2 )$$

In Equation (2), RxP_{j′j} is a received power that a j-th base station receives from a j′-th base station, SFⱼ is an SF of the j-th base station, UsedFAⱼ is Frequency Allocation (FA) of the j-th base station, Setⱼ is a value indicating a cyclic shift index set of the j-th base station, and J represents the number of indoor base stations located in a specific zone to which a cyclic shift index set is allocated.

More particularly, the control system calculates a cost function with respect to a total of J cyclic shift index sets of an indoor base station (P/Nₖ)^{J} times to determine a cyclic shift index set minimizing the cost function. The cyclic shift index set determined in the foregoing method may be allocated to each indoor base station to minimize a total amount of indoor interference. Alternatively, to reduce complexity in calculation of cost function, a meta-heuristic search, such as a Tabu search may be used.

In step 208, the cyclic shift indexes included in the determined cyclic shift index set are allocated to a corresponding indoor base station.

It should be noted that an operation flow chart illustrated in FIG. 2 does not limit the scope of the present invention. That is, during the procedure, OTAR execution in step 200, combination of an OTAR result with an estimated SF in step 202, division of P cyclic shift indexes in step 204, determination of cyclic shift index set minimizing cost function in step 206, or allocation of determined cyclic shift index in step 208 are operated by a controller (not shown) by way of example only. Exemplary embodiments of the present invention are not limited to be implemented by inclusion of all procedures or to be separately performed by a specific calculation and algorithm.

Separate indoor base stations acquire a use shift value of an outdoor base station as a result obtained through an OTAR operation to construct a Shift Value (SV) selection rejection list DenySVlistⱼ. The control system collects shift value selection rejection lists DenySVlistⱼ from the separate indoor base stations and excludes them, so as to prevent each indoor base station from selecting a shift value within a corresponding list as a use shift value. All P/Nₖ indoor base stations using different cyclic shift indexes are required to use the same shift value as much as possible, so as to increase orthogonality.

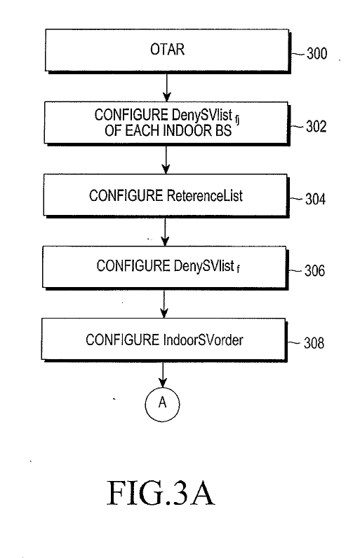

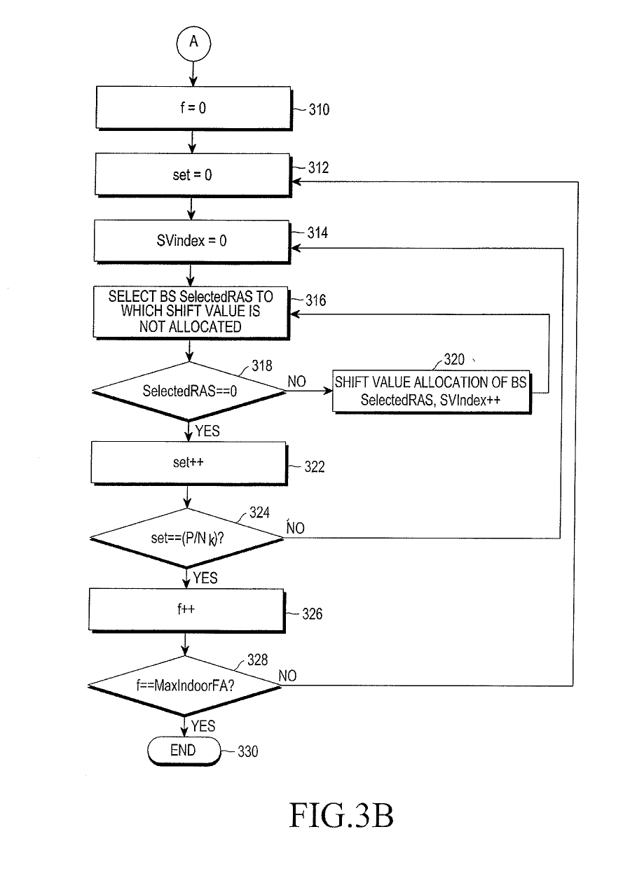

FIGS. 3A and 3B illustrate a procedure of allocating a shift value according to an exemplary embodiment of the present invention.

Referring to FIGS. 3A and 3B, each indoor base station performs an OTAR operation to acquire a wireless environment between a neighbor outdoor base station and a neighbor indoor base station in step 300. For example, the OTAR operation includes an operation collecting a receiving Carrier to Interference/Noise Ratio (CINR) to an indoor base station from an outdoor base station.

In step 302, a rejection list DenySVlist_{fj} of each indoor base station is configured as defined by Equation (3) below, by using a use shift value of an outdoor base station determined to be present as a result of the OTAR.

{UsedSVᵢ|CINRᵢⱼ≧OTAR_{sensitivity},UsedFAⱼ=f}εDenySVlist_{fj} (3)

In Equation (3), UsedSVᵢ is a shift value used by an outdoor base station i, CINRᵢⱼ is a CINR from an outdoor base station i to an indoor base station j, and OTAR_{sensitivity} is a threshold value determining the presence of an outdoor base station. Namely, the rejection list DenySVlistⱼ of each indoor base station contains a use shift value of an outdoor base station with a CINR equal to or greater than the threshold value and using the same FA as that of a corresponding indoor base station.

In step 304, each indoor base station configures an indoor base station list ReferenceListⱼ determined to be present as the OTAR. In the same manner in determining presence of an outdoor base station, it can be determined whether there is an indoor base station by comparing a CINR from another indoor base station with a certain threshold value.

In step 306, the control system configures DenySVlist_{f} with a union of sets by FAs of DenySVlist_{fj} constructed by each indoor base station, and configures a possible shift value list IndoorSVorder_{f} constructed by the remaining shift values except for shift values included in the DenySVlist_{f} in step 308.

In other words, the control system arranges shift values in an increasing order using shift values remaining after the removal of DenySVlist_{f} from a total of 128 shift values, so as to configure IndoorSVorder_{f}. Furthermore, shift values included in DenySVlist_{f} among a shift value set including a total of 128 shift values are arranged in the remaining parts of the IndoorSVorder_{f} in an order of farther outdoor base stations from the nearest outdoor base station among the indoor base stations using each shift value in the DenySVlist_{f} (i.e., in a decreasing order according to the distance from the outdoor base station).

Next, the control system allocates shift values to all indoor base stations by allocating a shift value to each indoor base station, each cyclic shift index set, and each usable FA (steps 310 through 328).

In step 310, the control system sets an FA of the lowest band among FAs usable by an indoor base station as an index f indicating a current FA. That is, FAs usable by the indoor base station are arranged in a decreasing order from the lowest band to the highest band and sets an index indicating an FA of the lowest band to 0. Furthermore, an f being the current FA is set to 0.

In step 312, a set being an index of a current cyclic shift index set is set to O.

In step 314, an index SVindex_{f} of a current shift value is initialized to 0.

In step 316, the control system selects a base station, which is included most frequently in ReferenceListⱼ of another indoor base station and has not yet been allocated a shift value, from indoor base stations, which are using an FA identical with f and a cyclic shift index set identical with set, as Selected Remote Access Service (RAS). The selection of the SelectedRAS can be defined by Equation (4) below.

$$arg {max}_{j} ( n \{ {j}^{′} \vert j ∈ {ReferenceList}_{j} \} ) ∈ SelectedRAS , \\ \{ j \vert {UsedFA}_{j} = f , {UsedSet}_{j} = set , {UsedSV}_{j} = - 1 \} \qquad ( 4 )$$

In Equation (4), n{jεReferenceListⱼ} means the number of inclusions of each indoor base station in ReferenceListⱼ of other indoor base stations.

In step 318, the control system determines whether there is no indoor base station to which the shift value is not allocated, namely, whether SelectedRAS is not an empty set (‘0’). If it is determined in step 318 that the SelectedRAS is not the empty set, the control system can determine that there is no indoor base station to which the shift value is not allocated.

As a result of the determination in step 318 that the SelectedRAS is not an empty set, namely, when there is an indoor base station to which the shift value is not allocated, the control system allocates the (SVindex_{f})^{th} shift value in IndoorSVorder_{f} as a use shift value for a base station included in SelectedRAS and increases SVindex_{f} by one in step 320. An operation allocating a use shift value of an indoor base station included in SelectedRAS can be defined by Equation (5) below.

UsedFAⱼ=IndoorSVorder_{f}(SVindex_{f}) (5)

After allocating a use shift value of an indoor base station included in SelectedRAS, the control system returns to step 316 and performs selection of an indoor base station to which the shift value is not allocated. That is, until use shift values of all indoor base stations with a used FA identical with f and a used cyclic shift index set identical with set are selected, steps 316, 318, and 320 are repeated.

In contrast, if it is determined in step 318 that the SelectedRAS is the empty set, namely, when no base station to which a shift value is allocated remain longer, the control system increases the set by 1 in step 322, and determines whether set indicating a used cyclic shift index set is identical to P/Nₖ in step 324.

If it is determined in step 324 that the set differs from P/Nₖ, because there are cyclic shift index sets to which the shift value is not allocated yet, the control system returns to step 314 and repeats steps 314 through 322.

As illustrated earlier, a shift value is allocated to all cyclic shift index sets 0˜(P/Nₖ−1).

In contrast, if it is determined in step 324 that the set is identical with P/Nₖ, the f is increased by 1 in step 326, and the control system determines whether a used frequency index f is identical with a maximum value MaxIndoorFA of an index indicating an FA usable by each indoor base station in step 328.

If it is determined in step 328 that the f differs from the MaxIndoorFA, because there are FAs to which a shift value is not allocated yet, the control system returns to step 312 and repeats steps 312 through 326. As described above, a shift value is allocated to all FA indexes 0˜(MaxIndoorFA−1).

In contrast, if it is determined in step 328 that the f is identical with the MaxIndoorFA, because no FA to which a shift value is not allocated remains, a routine finishes in step 330.

By repeatedly performing the foregoing procedures of FIG. 3B, an automatic allocation of a shift value to all indoor base stations with respect to all cyclic shift index sets for all FAs that an indoor base station can use becomes possible.

As described above, when a cyclic shift index set and a shift value are determined for respective indoor base stations, sounding sequences with the determined cyclic shift index set and the shift value are allocated to a corresponding indoor base station.

It should be noted that operation flowcharts illustrated in FIGS. 3A and 3B do not limit the scope of the present invention. That is, during the procedure, operations from step 300 through step 330 are operated by a control system (or controller) by way of example only. However, exemplary embodiments of the present invention are not limited to be implemented by inclusion of all procedures or to be separately performed by a specific calculation and algorithm.

The foregoing operation may be implemented by mounting a memory device storing a corresponding program code in an optional arrangement unit in a control system (or controller). That is, respective constructions of the control system can execute the foregoing operation by reading and executing a program code stored in a memory device by a processor or a Central Processing Unit (CPU).

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for allocating a sounding sequence to a plurality of indoor base stations in a wireless communication system, the method comprising:
determining a cyclic shift index set different from a cyclic shift index set used by at least one second indoor base station among the plurality of indoor base stations;
determining a shift value different from a shift value used by at least one indoor base station located at a periphery; and
allocating a sounding sequence, having the determined shift value and cyclic shift indexes included in the determined cyclic shift index set, to a first indoor base station.

2. The method of claim 1, wherein the determined shift value is determined to be identical with a shift value used by the second indoor base station.

3. The method of claim 1, wherein the determined cyclic shift index set is identical with a cyclic shift index set used by at least one third indoor base station among the plurality of indoor base stations, and the determined shift value differs from a shift value used by the third indoor base station.

4. The method of claim 1, wherein the cyclic shift index set is determined such that a total amount of interference between the first indoor base station and other indoor base stations becomes a minimum value.

5. The method of claim 4, wherein the cyclic shift index set is determined to minimize a cost function defined by:
$$Costfunction = {\sum }_{j = 1}^{J} ( ( {\sum }_{{{j}^{′} = 1}_{{{j}^{′} \neq j}_{{{UsedFA}_{{j}^{′}} = {UsedFA}_{j}}_{{Set}_{{j}^{′}} = {Set}_{j}}}}}^{J} {RxP}_{{j}^{′} j} ) / {SF}_{j} ) ,$$
wherein RxP_{j′j} is a received power that a j-th base station receives from a j′-th base station, SFⱼ is a Shadowing Factor (SF) of the j-th base station, UsedFAⱼ is Frequency Allocation (FA) of the j-th base station, Setⱼ is a value indicating a cyclic shift index set of the j-th base station, and J represents the total number of indoor base stations.

6. The method of claim 1, wherein the allocating of the sounding sequence to the first indoor base station is achieved with respect to all frequency allocations usable by the first indoor base station.

7. The method of claim 1, wherein the sounding sequence is generated by applying the cyclic shift index and the shift value to a fundamental sequence.

8. The method of claim 1, wherein a rejection list DenySVlist_{fj} of each indoor base station is configured by using a use shift value of an outdoor base station determined to be present as a result of an Over The Air Receive (OTAR) operation and is defined by:
{UsedSVᵢ|CINRᵢⱼ≧OTAR_{sensitivity},UsedFAⱼ=f}εDenySVlist_{fj},
wherein UsedSVᵢ is a shift value used by an outdoor base station i, CINRᵢⱼ is a Carrier to Interference/Noise Ratio (CINR) from the outdoor base station i to an indoor base station j, and OTAR_{sensitivity} is a threshold value determining the presence of the outdoor base station.

9. The method of claim 8, wherein the rejection list DenySVlistⱼ of each indoor base station contains a use shift value of an outdoor base station with a CINR equal to or greater than the threshold value and using the same Frequency Allocation (FA) as that of a corresponding indoor base station.

10. A control system for allocating a sounding sequence to a plurality of indoor base stations in a wireless communication system, the control system comprising:
a controller for determining a cyclic shift index set different from a cyclic shift index set used by at least one second indoor base station among the plurality of indoor base stations, and for determining a shift value different from a shift value using at least one indoor base station located at a periphery,
wherein the sounding sequence, having the determined shift value and cyclic shift indexes included in the determined cyclic shift index set, is allocated to a first indoor base station.

11. The control system of claim 10, wherein the control system determines the shift value for the first indoor base station to be identical with a shift value used by the second indoor base station.

12. The control system of claim 10, wherein the control system determines the cyclic shift set for the first indoor base station to be identical with a cyclic shift index set used by at least one third indoor base station among the plurality of indoor base stations, and
the determined shift value for the first indoor base station is different from a shift value used by the third indoor station.

13. The control system of claim 10, wherein the control system determines the cyclic shift index set for the first indoor base station such that a total amount of interference between the first indoor base station and other indoor base stations becomes a minimum value.

14. The control system of claim 13, wherein the control system determines the cyclic shift index set for the first indoor base station to minimize a cost function defined by:
$$Costfunction = {\sum }_{j = 1}^{J} ( ( {\sum }_{{{j}^{′} = 1}_{{{j}^{′} \neq j}_{{{UsedFA}_{{j}^{′}} = {UsedFA}_{j}}_{{Set}_{{j}^{′}} = {Set}_{j}}}}}^{J} {RxP}_{{j}^{′} j} ) / {SF}_{j} ) ,$$
wherein RxP_{j′j} is a received power that a j-th base station receives from a j′-th base station, SF_{S} is a Shadowing Factor (SF) of the j-th base station, UsedFAⱼ is Frequency Allocation (FA) of the j-th base station, Setⱼ is a value indicating a cyclic shift index set of the j-th base station, and J represents the total number of indoor base stations.

15. The control system of claim 10, wherein the control system allocates a sounding sequence to a first indoor base station with respect to all frequency allocations usable by the first indoor base station.

16. The control system of claim 10, wherein the cyclic shift index and the shift value are applied to a fundamental sequence to generate the sounding sequence.

17. The control system of claim 10, wherein a use shift value of an outdoor base station determined to be present as a result of an Over The Air Receive (OTAR) operation configures a rejection list DenySVlist_{fj} of each indoor base station defined by:
{UsedSVᵢ|CINRᵢⱼ≧OTAR_{sensitivity},UsedFAⱼ=f}εDenySVlist_{fj},
wherein UsedSVᵢ is a shift value used by an outdoor base station i, CINRᵢⱼ is a Carrier to Interference/Noise Ratio (CINR) from the outdoor base station i to an indoor base station j, and OTAR_{sensitivity} is a threshold value determining the presence of the outdoor base station.

18. The control system of claim 17, wherein the rejection list DenySVlistⱼ of each indoor base station contains a use shift value of an outdoor base station with a CINR equal to or greater than the threshold value and using the same Frequency Allocation (FA) as that of a corresponding indoor base station.
